(19) United States
(12) Patent Application Publication
(10) Pub. No.: US 2009/0265326 A1
(43) Pub. Date: Oct. 22, 2009

(54) DYNAMIC PERSONAL PRIVACY SYSTEM FOR INTERNET-CONNECTED SOCIAL NETWORKS

(76) Inventors: THOMAS DUDLEY LEHRMAN, New York, NY (US); Evan John Kaye, Short Hills, NJ (US)

Correspondence Address: Bryan Cave LLP, 1290 Avenue of the Americas, New York, NY, 10104, US

(21) Appl. No.: 12/209,157

(22) Filed: Sep. 11, 2008

Related U.S. Application Data
(60) Provisional application No. 61/045,701, filed on Apr. 17, 2008.

(51) Int. Cl. G06F 17/30

(52) U.S. Cl. 707/4; 707/E17.014

(57) ABSTRACT

Systems and methods of obtaining or providing search results in a computer-based social network in a manner that allows users to maintain a certain level of control over their privacy, and systems and methods of controlling undesired unsolicited communications between users in a computer-based social network. Users enter privacy settings which are used to filter search results by comparing privacy settings to available data concerning the searcher. Users are identified in the searches only if the searcher meets the privacy settings provided by the user. Privacy settings may include permission search terms, identification of a school, evaluating the number of connections of the searcher, evaluating a number or percentage of common connections between the user and the searcher, or a combination thereof as examples.

### CLAIM OF PRIORITY

This patent application claims priority to U.S. Provisional Patent Application No. 61/045,701, titled DYNAMIC PERSONAL PRIVACY SYSTEM FOR INTERNET-CONNECTED SOCIAL NETWORKS, filed on 17 Apr. 2008, and naming Thomas D. Lehrman and Evan J. Kaye as inventors, which is incorporated herein by reference in its entirety.

### FIELD OF THE INVENTION

The present invention relates to systems and methods which allow a user of an internet-connected social network to control their privacy within the social network.

### BACKGROUND OF THE INVENTION

Internet-connected social networks have become increasingly popular for personal and business networking. An Internet-connected social network typically has a mechanism for a user to register and create a profile that is visible to other users of the social network. It also gives users the ability to link in some way to others within the social network. Such linking may be termed “friends”, “connections”, “colleagues”, or suchlike (referred to generically as “connections” throughout this document) and is typically accomplished through one user inviting a second user to link to them through an Internet-connected device. The second user typically has had the ability to accept or reject the invitation to connect with the first user.

If a first user is connected to a second user, the first user may be granted increased privileges with respect to the second user. For instance, the first user may be able to view more profile details of the second user (e.g., company affiliation, email address), that may enable the first user to communicate more easily with the second user. This relationship may be reciprocal in that the second user may have the same privileges concerning the first user. The number of connections that a user has may be reported in their profile, and users with many connections have been held to be in higher status in the social network community as a result of the many users who have independently invited them to connect, or have accepted their invitation to connect.

In order for a first user to find a second user, social networks typically provide users the ability to search for other users in the social network through an internet-connected device such as a personal computer. This mechanism makes it easy for users to find other users they know through attributes that appear in the person's profile, whether it be their name, a school they attended, or a company they may have worked for, as examples. Most social networks allow a user to find any other user through the results of such a search.

Some social networks give users the ability to control whether or not they can be found by other users depending on attributes and permissions the searcher has associated with their account. For instance, if a first user has been authenticated as attending a particular school (this authentication may have been performed by verifying that they have access to an email account with that school's domain name, for example) then they may have the ability to see other users that attend that school in their search results, but may not have permission to view users that do not attend that school, for example.

Once a user has found a second user through searching, it has typically been easy for the first user to invite the second to connect. The invitation sent by the first user has triggered an alert or message to the second user with the invitation from the first user, for example, and a mechanism has been provided whereby they can accept, reject or ignore the request to connect with the first user. The ease at which the invitation is generated to the second user has been favorable for the user that is establishing connections with users they legitimately know outside of the social network.

Because users with many connections have increased status in the social network community, some users have tended to elevate their status by attempting to connect with many people in the network, even those that they have never met or communicated with outside of the social network or prior to their participation in the social network. A message or alert has typically been sent to the invitee every time an invitation is sent, therefore, these unsolicited invitations may reduce the productivity of or be a distraction to the invitee.

Furthermore, as the barrier to connecting with someone is generally substantially lower than seeking to correspond with that person outside of the social network, due to reduced search and communication-related transaction costs, some users have tended to engage other users whom they would not normally take the time or effort to engage outside of the social network. For this reason, many popular people (e.g., prominent professionals, community leaders, noted authors or scholars, and celebrities) have refrained from joining social networks as they have wished to avoid the volume of invitations and communications they would likely receive in the event they did join such networks.

Another problem with social networks is the costs for many users associated with the time required to establish connections with persons they already have met or communicated with outside of the social network has outweighed the benefits that come from establishing such connections. One benefit for users, as mentioned, has been the opportunity to increase one's status in the social network community, so-called “bragging rights” that come from having many connections. Another benefit is that users have been able to easily manage their contacts and keep up to date with their connections' contact and professional details. A further benefit is that users have been able to leverage search tools to map out how they might know someone through other people, which is particularly useful in business networking. A social network grows faster if it can demonstrate to its users that the benefits from inviting and connecting with other users and inviting new users into the community outweighs the direct and opportunity costs associated such processes.

Further, many parents have refrained from allowing their children to participate in computer-based social networks out of concern that their child may be contacted by a person who may be a threat to them such as a criminal or someone who has been convicted of a particular type of crime, or a crime against children, as examples.

Thus, needs and areas for potential benefit or improvement exist for social networks and routines within social networks, wherein users have the option to control or limit which other users communicate with them to establish connections. Other needs, areas for potential benefit, and desires may be apparent to a person of ordinary skill in the art having studied this document.

### SUMMARY OF EXAMPLES OF EMBODIMENTS OF THE INVENTION

Some embodiments of the invention provide a mechanism that may enable a specific user of an online social network to establish that their personal profile will be revealed (in part or in entirety) only to those searchers or other users that have met particular qualifications with respect to the number of connections they have or attributes in their profile or in one or more other databases, as examples. This may provide the specific user with the ability to control accesses to their private information, or that of their children for example, based on the searcher's attributes, for instance.

In particular embodiments, specific qualifications may include: (i) the absolute number of connections; (ii) the percentage of connections they have within the entire social network; (iii) the number of connections they have within a specific group or sub-network within the entire social network; (iv) the percentage of connections they have within a specific group or sub-network within the entire social network; (v) the number of common connections; (vi) the percentage of common connections; (vii) the number of profile features in common (percentage or absolute number); (viii) the results of a background check, or a combination thereof, as examples.

In various embodiments, a dynamic personal privacy system may enable a specific user to adjust to whom his or her identity and profile (or that of the specific user's children) is revealed or hidden within the social network, in some embodiments, without having to make manual updates to his or her privacy profile. In certain embodiments, a system may also enable the specific user to manage in an automated manner the evolution of his presence or absence to particular other users (e.g., searchers) within the social network, as a result of changes in the nature of the other user's or searcher's connections or as the size and user characteristics of the social network or sub-networks evolve, or a combination thereof, for instance.

Various embodiments may be an especially useful feature for busy or prominent professionals or community leaders, as examples, who wish to enjoy the full benefits of online social networks, for personal or professional reasons, without the loss of privacy and time wasted receiving messages from persons or searchers who have seen their profile and sought to interact with them on an unsolicited basis, for example. In certain embodiments, a popular person may enjoy the benefits associated with being a user in a social network but not be subject to harassment from users or searchers that have little in common in the social network community, or low relevance to the popular person's interests. This approach may also provide economic and social benefits to society, by for example ensuring that those currently opting out of social networks can find utility through their participation and more efficiently interact and communicate with other users.

In certain specific embodiments, this invention provides, among other things, various methods of obtaining or providing search results in a computer-based social network in a manner that allows users to maintain a certain level of control over their privacy. These methods generally include, in various orders, at least certain acts. One such act, for example, in some embodiments, is an act of receiving at a web server, from specific users of the computer-based social network, for instance, one or more privacy settings for each of the specific users, for example, for allowing searchers, who may be other users, to access information concerning each of the specific users. In some embodiments, the privacy settings include at least one permission search term for each of the specific users, for example.

Another act, in some embodiments, is an act of receiving at a web server, for instance, a request from a searcher, who may be a user of the computer-based social network, for example, to view specific users in the computer-based social network that match at least one particular search term. In some embodiments, this particular search term is provided by the searcher with the request, for example. At least one act, in some embodiments, involves searching a membership or user database to find users of the computer-based social network that match the at least one particular search term previously mentioned. In some embodiments, the user database contains information concerning the users of the computer-based social network, for example.

Another act, in a number of embodiments, involves filtering out results that the searcher does not have permission to review. In particular, in some embodiments, for example, the results are from the searching of the user database, and the permission is controlled by the specific users of the computer-based social network that were identified in the searching of the user database. In particular embodiments, for instance, the searcher has a biography database and the filtering out includes evaluating whether the permission search term previously mentioned is found in the biography database of the searcher. Further, certain embodiments include an act of returning to the searcher, for display in the searchers browser, for instance, a list of the specific users of the computer-based social network that match the at least one particular search term and that the searcher has permission to review, but excluding any specific users of the computer-based social network that the searcher does not have permission to review.

In some embodiments, the privacy settings specifically include an option for the specific users to enter a required number of connections that a searcher must have for example, and the act of filtering out includes filtering out any of the specific users who require in privacy settings a required number of connections that is more than the actual number of connections existing for the searcher, for instance. Moreover, in particular embodiments, the act of returning to the searcher the list of the users includes communicating to the searcher circumstances under which the searcher would have permission to view more of the specific users of the computer-based social network that match the particular search term, for instance. Further, in some embodiments, these circumstances include the searcher having more connections with other users of the computer-based social network, for example.

Further, in some embodiments, the privacy settings include a specific option for the specific users to enter a required number of connections that a searcher must have in common with the specific user, as another example, and the act of filtering out includes filtering out any of the specific users who require in privacy settings a required number of connections in common that is more than the actual number of connections in common existing with the searcher at that time, for example.

In a number of embodiments, for instance, the privacy settings include an option for the specific users to enter a required percentage of connections that the searcher must have, and the act of filtering out includes filtering out any of the specific users who require in privacy settings a required percentage of connections that is more than the actual percentage of connections existing for the searcher. In some embodiments, this percentage is a percentage of the total number of users in the computer-based social network, for example.

Further still, in certain embodiments, the privacy settings specifically include an option for the specific users to enter a required number of common profile features that a searcher must have, and the act of filtering out includes filtering out any of the specific users who require in privacy settings a required number of common profile features that is more than the actual number of common profile features existing for the searcher. Furthermore, in some embodiments, the act of returning to the searcher the list of the specific users that match the particular search term and that the searcher has permission to review includes communicating to the searcher circumstances under which the searcher would have permission to view more of the specific users of the computer-based social network that match the at least one particular search term.

Even further, in particular embodiments, this communicating to the searcher circumstances under which the searcher would have permission to view more of the specific users of the computer-based social network that match the at least one particular search term, is performed only if the list of the specific users of the computer-based social network that match the at least one particular search term exceeds a threshold, for example.

In some specific embodiments, the privacy settings include an option for the specific users to request that a background check be performed, for example, via the Internet. In particular embodiments, when at least one of the specific users of the computer-based social network that match the at least one particular search term has requested that the background check be performed, the method includes an act of performing the background check on the searcher. Further, in various embodiments, if the searcher fails the background check, the method includes an act of filtering out the specific users of the computer-based social network that match the at least one particular search term, for example, that requested that the background check be performed. Certain such methods include an act of returning to the searcher, for display in the searcher's browser, for example, a list of the specific users of the computer-based social network that match the at least one particular search term and that have not requested that the background check be performed, but excluding specific users of the computer-based social network that requested that the background check be performed, for instance.

Besides various methods of obtaining or providing search results in a computer-based social network in a manner that allows users to maintain a certain level of control over their privacy, this invention also provides a number of systems and methods of controlling undesired unsolicited communications between users in a computer-based social network. Various methods include at least an act of obtaining or providing a search mechanism for searchers, who may be users of the social network, for example, to be able to search for specific users meeting a search criteria provided by the searchers, for example. Further, certain embodiments include an act of obtaining or providing a privacy mechanism for specific users of the social network to be able to enter privacy settings (e.g., provided by the specific users), as another example. In some embodiments, the privacy settings may define characteristics of the searchers, for instance.

Still further, various embodiments include an act of obtaining or providing a screening mechanism for screening search results In some embodiments, when the search mechanism identifies a specific user meeting the search criteria the screening mechanism then evaluates whether the searcher meets the privacy settings provided by that specific user via the privacy mechanism, for example. In certain embodiments, this specific user is identified to the searcher only if the searcher meets the privacy settings entered through the privacy mechanism by the specific user, for example.

A number of embodiments further include an act of obtaining or providing an identification mechanism that identifies to the searchers the specific users identified by the search mechanism that are not screened out by the screening mechanism. Further, in some such embodiments, the identification mechanism includes instructions to communicate to the searcher circumstances under which the searcher would have permission to view more of the specific users of the computer-based social network, for example, that were identified by the search mechanism.

In particular embodiments, the identification mechanism includes instructions to communicate to the searcher circumstances under which the searcher would have permission to view more of the specific users of the computer-based social network that were identified by the search mechanism, only if the list of the specific users identified by the search mechanism exceeds a threshold, for instance.

In particular embodiments, the privacy settings specifically include a school attended by the searcher, a number of connections of the searcher within the social network, or both, as examples. In some embodiments, the act of evaluating whether the searcher meets the privacy settings provided by the specific user via the privacy mechanism includes evaluating whether a school attended by the searcher is the same as a school attended by the specific user, for instance.

Moreover, in various embodiments, the number of connections mentioned above includes a total number of the searcher's connections, or the social network may include multiple specific groups which include a particular specific group, and the number of connections may include a total number of the searcher's total connections that are within the particular specific group, for example. In fact, in some embodiments, the social network includes multiple specific groups which include a particular specific group, and the number of connections includes a percentage of the searcher's total connections that are within the particular specific group, for instance.

On the other hand, in some embodiments, the number of connections includes a total number of common connections between the searcher and the specific user, for example. Further, in some embodiments, the number of connections includes a percentage of the searcher's total connections that are common connections between the searcher and the specific user, as another example.

A number of embodiments specifically include an act of obtaining or providing a background check mechanism to perform background checks on the searchers or on users of the social network, for example. In some embodiments, the background check mechanism is configured to access at least one external database over a wide area network, for example, in order to perform the background checks. In some such embodiments, the screening mechanism evaluates whether the searcher meets the privacy settings provided by the specific user via the privacy mechanism for instance.

In particular embodiments, the screening mechanism uses at least one of the background checks to evaluate whether the searcher meets the privacy settings provided by the specific user via the privacy mechanism. Further, in a number of embodiments, communication from the searcher to the specific user is facilitated by a communication mechanism only if the searcher meets the privacy settings entered through the privacy mechanism by the specific user.

In some embodiments, when the search mechanism identifies a specific user meeting the search criteria, the screening mechanism then evaluates whether the searcher meets the privacy settings provided by the specific user via the privacy mechanism, for example. In certain embodiments, the specific user is identified to the searcher only if the searcher meets the privacy settings entered through the privacy mechanism by the specific user, for instance. Further, in a number of embodiments, the wide area network is specifically the Internet, the external database is a governmental database, or both. In addition, various other embodiments of the invention are also described herein.

### BRIEF DESCRIPTION OF THE DRAWINGS

FIG. 1 is a flow chart showing a process by which a searcher searches for specific users in a social network;

FIG. 2 is a block diagram showing a schematic representation of a social network;

FIG. 3 is a view showing an exemplary privacy settings page used by a social network user to control their privacy settings;

FIG. 4 is a view showing an exemplary search results page displaying examples of users in a social network;

FIG. 5 is a view showing an exemplary search results page displaying examples of users in a social network, where one result is hidden giving the searching user limited viewing privileges;

FIG. 6 is a view showing an exemplary search results page displaying examples of users in a social network, where some results are hidden and the searching user is advised that they could view more search results if they had more connections;

FIG. 7 is a flow chart illustrating an example of a method of obtaining or providing search results in a computer-based social network in a manner that allows users to maintain a certain level of control over their privacy;

FIG. 8 is a flow chart illustrating an example of a method of controlling undesired unsolicited communications between users in a computer-based social network or a method of obtaining or providing search results in a computer-based social network in a manner that allows users to maintain a certain level of control over their privacy;

FIG. 9 is a block diagram illustrating an example of a system for controlling undesired unsolicited communications between users in a computer-based social network, or a system of obtaining or providing search results in a computer-based social network in a manner that allows users to maintain a certain level of control over their privacy; and

FIG. 10 is a Venn diagram showing the number of contacts that two users of a computer-based social network may have and illustrating how numbers of contacts, numbers of contacts in common, and percentages of contacts in common between the two users may change over time.

### DETAILED DESCRIPTION OF EXAMPLES OF EMBODIMENTS

The invention is described in detail with particular reference to certain exemplary embodiments, but it is not limited to such embodiments. It will be apparent to those of skill in the art that various features, variations, and modifications can be included or excluded, within different embodiments and the requirements of a particular use.

Various embodiments provide interfaces and algorithms for a member or user in social network (or an adult guardian thereof) to control who is able to find their name or profile (or both) in a search or browsing context and then engage them. Numerous embodiments can be described by way of the accompanying drawings.

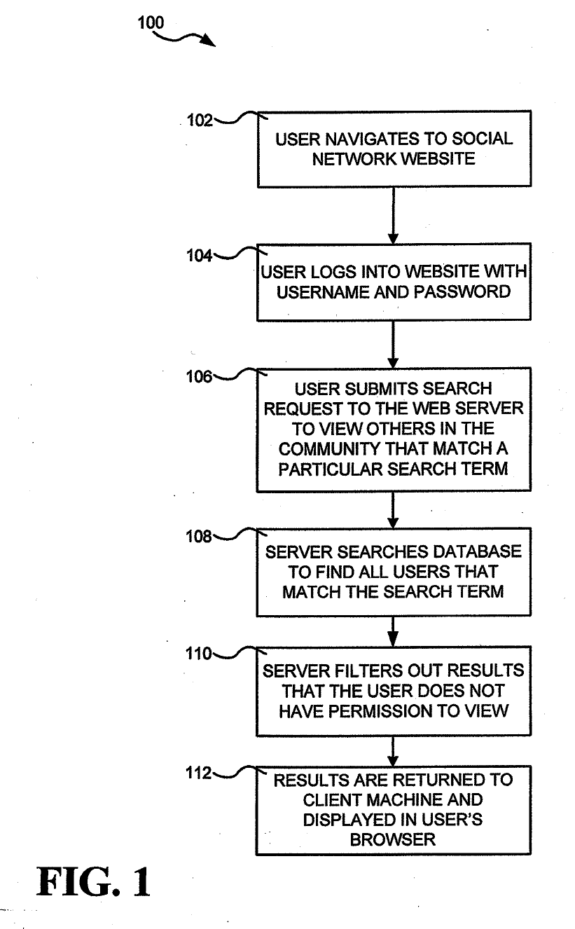

With reference now to FIG. 1, a flowchart shows an example of a process 100 by which a searcher (e.g., a member or user of the social network) may search for specific users (e.g., other users) in a social network. As a first act in this example, a user navigates to the social network website at act 102, and then logs into the website with their username and password at act 104. Once logged in, in this example, the user has privileges to view user-only content and edit their user profile settings, for example. At act 106, the user or searcher enters a search term and submits a search request to the web server, in this example, which may be used by the server to search a database at act 108, for instance.

In some embodiments, this search will return all specific users that match the search term back to server. At act 110, in particular embodiments, the server filters out search results that the logged-in user or searcher does not have permission to view, for instance, and returns the remaining results to the client machine or searcher at act 112, for example, to be displayed in the user's or searcher's browser. In certain embodiments, the search act 108 may be combined with the filtering act 110 through the use of access control lists, privacy criteria, permission criteria, permission settings, or privacy settings that may be stored in the same database that stores user data, for example.

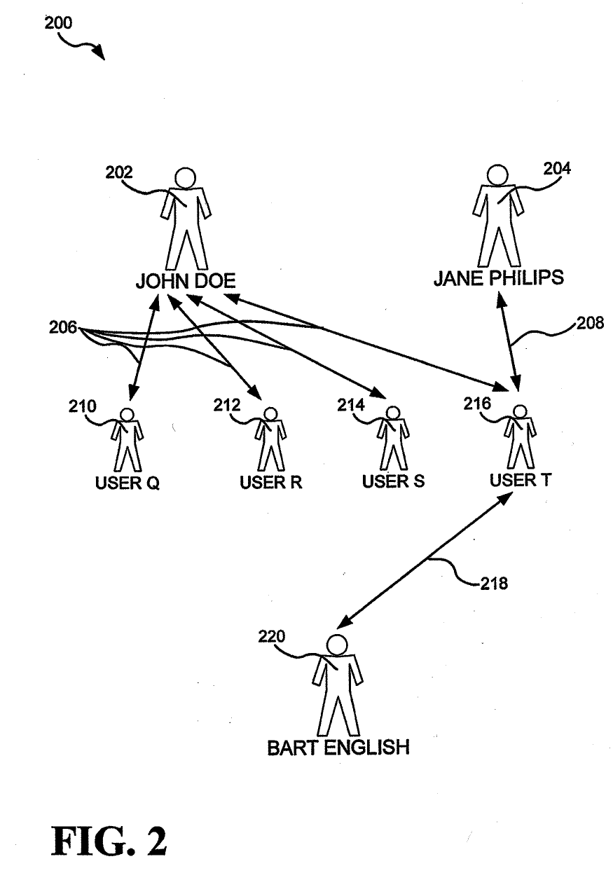

With reference now to FIG. 2, a schematic representation of part of a social network 200 is shown which illustrates an example of the manner in which seven members or users are connected to each other. In some embodiments, any of the members or users in social network 200 may perform acts 102, 104, and 106 shown in FIG. 1, for example, (e.g., may be searchers) or may be identified in results returned in act 112, (e.g., as specific users identified in a search) as another example.

Connections may be made, in various embodiments, by one user inviting another user to link to them. If the recipient accepts the invitation, then the users may be reciprocally connected to each other, for example. In the example shown, John Doe 202 has connections 206 to User Q 210, User R 212, User S 214 and User T 216 for instance. Another user, Jane Philips, has connections 208 to User T 216. Bart English 220 also has a connection 218 to User T 216 in this example. The permissions afforded by the connections, in some embodiments, will be described with reference to the following figures.

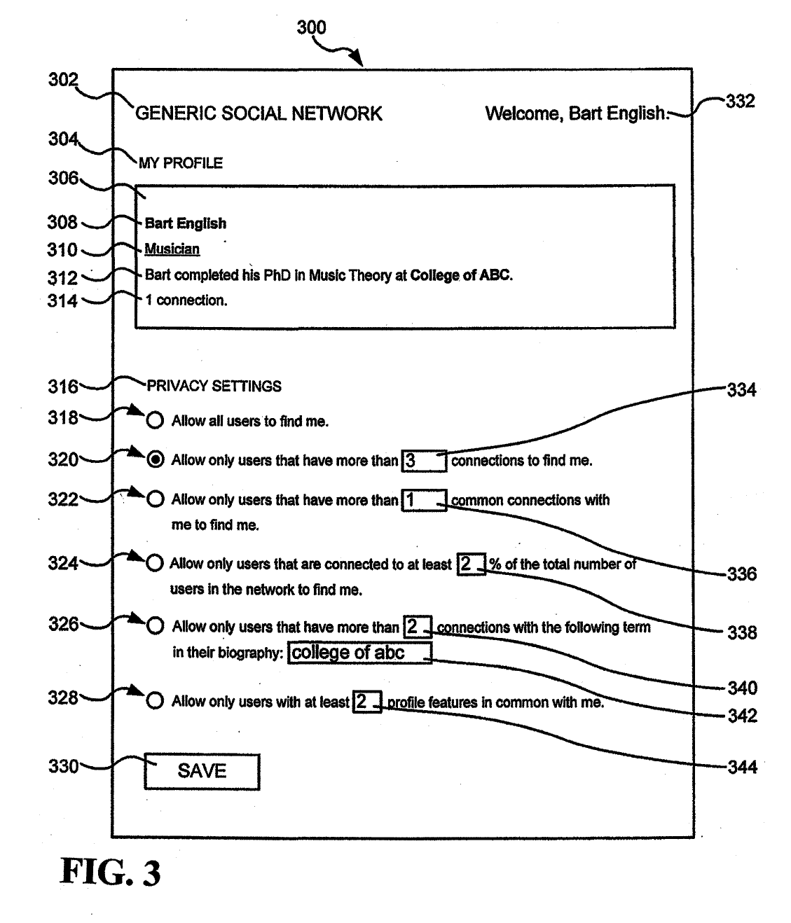

With reference now to FIG. 3, an exemplary privacy settings page 300 is shown that can be used by a social network user to control their privacy settings, for example. Privacy settings entered by a specific user into page 300, for example, may be used in act 110 of process 100 shown in FIG. 1 to decide whether to filter out that specific user from results provided to a searcher in act 112 of process 100, for instance.

At the top of the web page (e.g., page 300) is the name of the social network 302 as well as a welcome message 332 that indicates that Bart English 220 of FIG. 2, has logged in to his account. Below the name of the social network 302 is the My Profile 304 page header, and below that is the user's profile 306, with the user's name 308, title 310, short biography 312, and the number of connections they currently have 314.

Below the user's profile 306, in this example, is the Privacy Settings area with its header 316. In this example, the Privacy Settings area includes options where only one can be selected at any time by way of a radio-button. When the first option 318 is selected using its radio-button, then all searchers (e.g., all users) are allowed to find the specific user that is logged in, and the specific user's profile will appear in all applicable search results where a search term matches some data in their user profile. In different embodiments, when option 318 is selected, act 110 may be skipped, or act 110 may not filter out any results obtained in act 108, as examples.

Still referring primarily to FIG. 3, when the second option 320 is selected using its radio-button, on the other hand, then only those searchers or users (e.g., who perform acts 102, 104, and 106 in process 100 shown in FIG. 1) that have more than a certain number of connections are able to see this specific user in the search results (e.g., returned in act 112 of process 100), for another example. In this case, the specific user that has logged in (e.g., to page 300), Bart English 220 of FIG. 2, has selected this option, and has further specified the number of connections 334 needed by a person to find him as being “3” connections.

When the third option 322 on page 300 shown in FIG. 3 is selected using its radio-button, in this embodiment, then only those searchers that have at least a certain number of common connections with the specific logged-in user (e.g., who accessed page 300 shown in FIG. 3) are permitted to see this specific user in search results (e.g., returned in act 112 of process 100). In this case, the specific user that has logged in, Bart English 220 of FIG. 2, has not selected this option, but the default number of common connections in the text field 336 is “1” common connection.

In the embodiment illustrated, when the fourth option 324 is selected using its radio-button, then only those searchers or users (e.g., who perform acts 102, 104, and 106 in process 100 shown in FIG. 1) that are connected to a certain percentage of the entire user base are permitted to view (e.g., returned in act 112 of process 100) the specific user that has logged in, Bart English 220 of FIG. 2. In this case, the specific user that has logged in, Bart English 220 of FIG. 2, has not selected this option but the default percentage of user base required in the percentage input box 338 is “2%”, in this embodiment.

When the fifth option 326 in FIG. 3 is selected using its radio-button, in this embodiment, then only those users (e.g., who perform acts 102, 104, and 106 in process 100 shown in FIG. 1) or searchers that have more than a certain number of connections are able to see this specific user in the search results (e.g., returned in act 112 of process 100 of FIG. 1). In this case, the specific user that has logged in, Bart English 220 of FIG. 2, has not selected this option, but the number of connections 340 needed by a member or user (e.g., who perform acts 102, 104, and 106 in process 100 shown in FIG. 1) or searcher to find Bad English 220 is specified as being “2” connections should the radio-button 326 be selected.

In addition, for this selection, in this embodiment, these connections need to have a certain term in their biography, which is specified in the term box 342. In this case, the term specified is “college of abc”. Other terms may be used, such as a term used in a particular profession, a geographic term, a term concerning a particular sport (e.g., racquetball), hobby (e.g., bola tie making), or recreational activity (e.g., kayaking), or the like.

When the sixth option 328 is selected using its radio-button, in this example, then only those users (e.g., who perform acts 102, 104, and 106 in process 100 shown in FIG. 1) or searchers with at least a certain number of profile features in common with the specific user (Bart English, in this case) will be permitted to view the specific user. In this case the number of profile features required in the input box 344 is 2. In various embodiments, profile features may include, for example: title, institution name, or previous institutions attended, as examples.

The Save Button 330 saves the settings, in this embodiment, when the logged-in user changes their selections (e.g., to be used in act 110 of process 100 shown in FIG. 1, to filter results). Other embodiments may use a different web page for data entry, may offer different selections, or both. In some embodiments, for example, a specific user may be able to select a combination of multiple criteria or settings to limit what searchers may see their name, profile data, or the like, or to limit who may find them in a search (e.g., in results returned in act 112 shown in FIG. 1, for example).

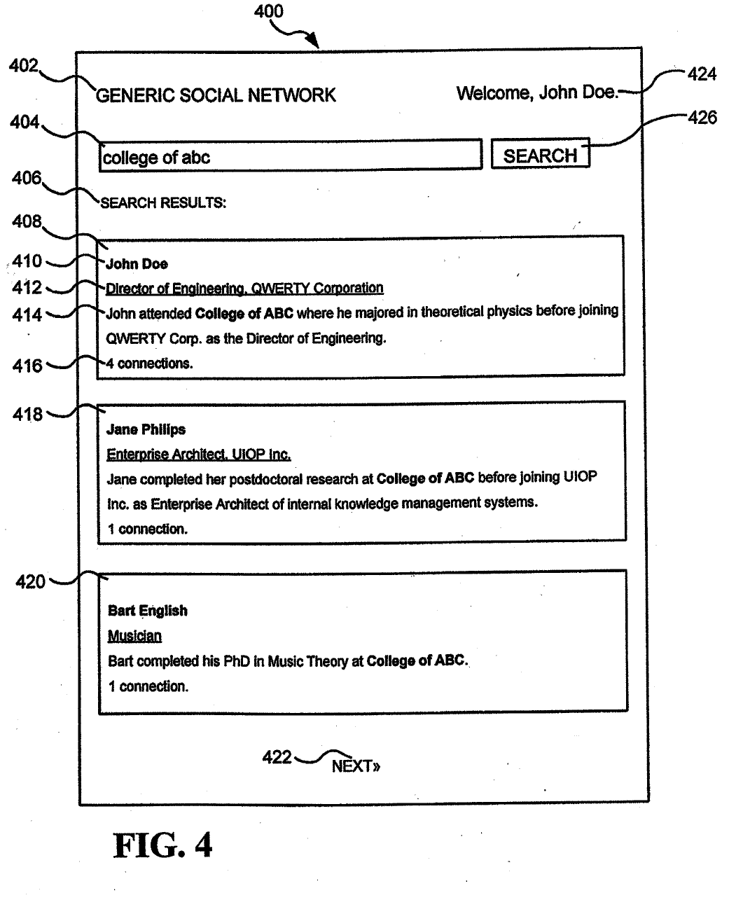

With reference now to FIG. 4, an exemplary search results page 400 is shown displaying users in a social network. Page 400 may be used to present results returned in act 112 shown in FIG. 1, for example. At the top of web page 400, in this example, is the name of the social network 402 as well as a welcome message 424 that indicates that John Doe 202 of FIG. 2, has accessed the social network through one or more Internet-connected devices (e.g., via acts 102 and 104 shown in FIG. 1), for example. Below the name of the social network 402 is a search term entry box 404 with its corresponding Search action button 426 for example.

When a user or searcher enters a search term in the search term entry box 404 and then clicks the Search action button 426 (e.g., in act 106 shown in FIG. 1), in this embodiment, the search results are displayed below on the page (e.g., in act 112 of process 100 shown in FIG. 1). In this embodiment, the search results have a Search Results header 406, for instance. In this particular example, three search results are shown, and the searcher is required to click the Next link 422 to navigate forward to further results. Each search result, in this embodiment, represents one specific user (e.g., examples of which are shown in FIG. 2).

In this example, the three specific users shown are for John Doe 202 of FIG. 2, Jane Philips 204 of FIG. 2, and Bad English 220 of FIG. 2, with their respective search results John Doe search result 408, Jane Philips search result 418 and Bad English search result 420. With reference to one exemplary search result, the John Doe search result 408, there is a name 410, title 412, short biography 414, and the number of connections they have 416, for instance.

In the example of page 400 shown in FIG. 4, since John Doe 202 of FIG. 2 is the searcher or the user who has accessed the social network through the particular search results page 400 shown, John Doe 202 is able to see Bart English 220 of FIG. 2 in the search results because John Doe 202 of FIG. 2 has the minimum number of connections required by Bad English 220 of FIG. 2 in Bart English's privacy criteria or privacy settings as defined by his privacy settings page 300 of FIG. 3. Thus, Bart English 220 has not been filtered out in act 110 of process 100 shown in FIG. 1, and is included in results returned in act 112. In this example, Bart English 220 of FIG. 2 has previously specified at least three connections in his privacy settings page 300 of FIG. 3.

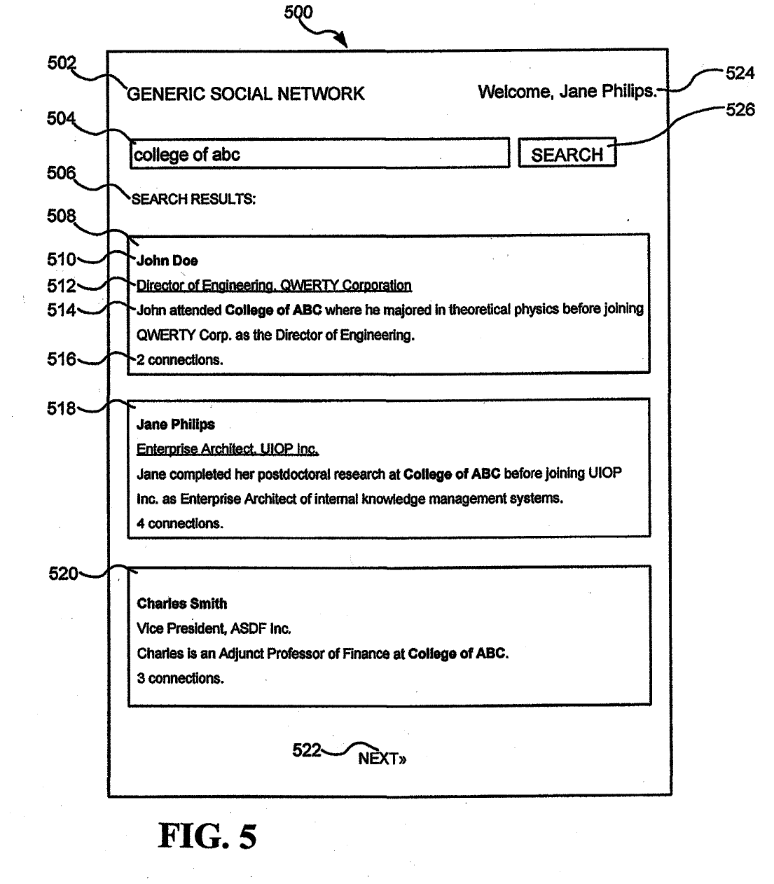

As another example, with reference now to FIG. 5, search results page 500 is shown that is similar to the search results page search results page 400 of FIG. 4. The difference is that Jane Philips 204 of FIG. 2 has now logged in (e.g., performing acts 102 and 104 shown in FIG. 1) as the searcher as shown in the welcome message 524. At the top of web page 500 is the name of the social network 502, below which is a search term entry box 504 with its corresponding Search action button 526. When a user or searcher enters a search term in the search term entry box 504 and then clicks the Search action button 526 (e.g., to submit a search in act 106 shown in FIG. 1), in this embodiment, the search results are displayed below on the page 500 (e.g., in act 112 shown in FIG. 1).

The search results (e.g., returned in act 112 shown in FIG. 1) have a Search Results header 506. In this example shown in FIG. 5, three search results are shown, and the user (e.g., who logged in and performed the search in acts 102, 104, and 106 shown in FIG. 1) or searcher is required to click the Next link 522 to navigate forward to further results. Each search result shown in FIG. 5 represents one specific user (e.g., shown in FIG. 2). In this example, the three specific users shown are John Doe 202 of FIG. 2, Jane Philips 204 of FIG. 2, and Charles Smith (an example of a specific user who matches the search term but is not represented elsewhere in the figures), with their respective search results: the John Doe search result 508, Jane Philips search result 518 and Charles Smith search result 520.

With reference to one exemplary search result for a specific user, the John Doe search result 508, there is a name 510, title 512, short biography 514, and the number of connections they have 516 for instance. In this example, the logged-in user (e.g., who performed acts 102, 104, and 106 shown in FIG. 1) or searcher, Jane Philips 204 of FIG. 2, does not have the necessary number of connections to view the user profile of Bart English 220 of FIG. 2 in the search results. As a result of the Bart English 220 search result being hidden (e.g., filtered out in act 110 shown in FIG. 1), the next relevant result has taken its place, and is that of the specific user “Charles Smith” as represented by the Charles Smith search result 520. Should Jane Philips 204 of FIG. 2 ever make the required number of connections, then Bart English 220 of FIG. 2 would show in the search results of the same search in this embodiment.

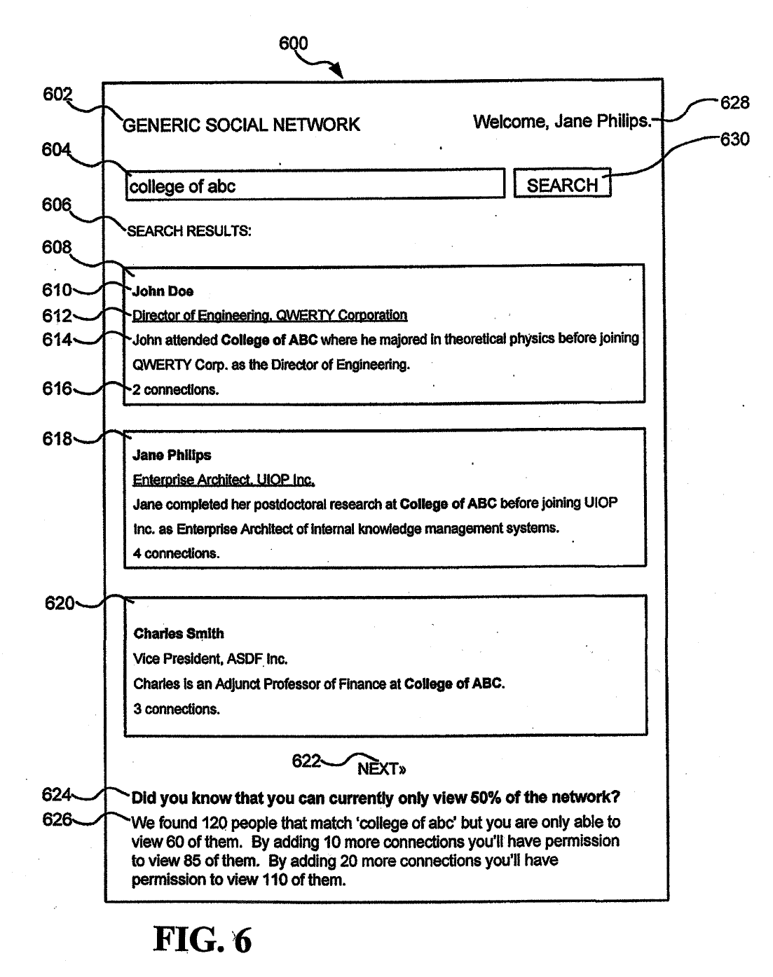

With reference now to FIG. 6, an alternative search results page 600 is shown to the search results page 500 of FIG. 5 (e.g., returning search results according to act 112 shown in FIG. 1). But page 600 provides or explains to the user (e.g., who logged in and performed the search in acts 102, 104, and 106 shown in FIG. 1) or searcher an incentive to add connections to their profile within the social network (e.g., 200 shown in FIG. 2). At the top of web page 600 is the name of the social network 602, below which is a search term entry box 604 with its corresponding Search action button 630, for example.

In FIG. 6, Jane Philips 204 of FIG. 2 is logged in as the searcher as indicated by the welcome message 628. When a user or searcher enters a search term in the search term entry box 604 and then clicks the Search action button 630 (e.g., in act 106 shown in FIG. 1), the search results are displayed (e.g., in act 112 shown in FIG. 1) below on page 600 for instance. The search results have a Search Results header 606. In this example, three search results are shown, and the user or searcher (e.g., Jane Philips 204) is required to click the Next link 622 to navigate forward to further results. Each search result represents one specific user, for example.

In this example, the three specific users shown are John Doe 202 of FIG. 2, Jane Philips 204 of FIG. 2, and Charles Smith (an example of a specific user who matches the search term but is not represented elsewhere in the figures), with their respective search results: the John Doe search result 608, Jane Philips search result 618 and Charles Smith search result 620. With reference to one exemplary search result, the John Doe search result 608, there is a name 610, title 612, short biography 614, and the number of connections they have 616.

The logged-in user (e.g., in act 104 shown in FIG. 1) or searcher, Jane Philips 204 of FIG. 2, (as shown in FIG. 2) does not have the necessary number of connections to view the user profile of specific user Bart English 220 of FIG. 2 in the search results. As a result of this search result being hidden (e.g., filtered out in act 110 of FIG. 1), the next relevant result has taken its place, and is that of the specific user “Charles Smith” as represented by the Charles Smith search result 620. In this embodiment, should searcher Jane Philips 204 of FIG. 2 ever make the required number of connections, then Bart English 220 of FIG. 2 would show in the search results of the same search.

In this embodiment, there is also a provocative question 624, and accompanying explanation 626 to provide searcher Jane Philips with a clear incentive to add more connections and thereby view some or all of the hidden search results (including that of specific user Bart English 220 of FIG. 2). In the explanation 626, in this embodiment, searcher Jane Philips 204 of FIG. 2, is given specific information as to how many people or specific users match the search term (e.g., entered in act 106 shown in FIG. 1, in search term entry box 604, or both) but are hidden from view (e.g., were filtered out in act 110 shown in FIG. 1). The explanation 626 also indicates to the searcher (e.g., Jane Philips 204), in this embodiment, how many more people or specific users the searcher would be permitted to view (e.g., in act 112, on page 600, or both) if the searcher added incremental numbers of connections.

In some embodiments, the website may selectively display the alternative search results page 600 of FIG. 6 or the search results page 500 of FIG. 5 depending on the number of search results, for example. Where there are many search results, and many search results hidden, for example, it is safe for the website to display the alternative search results page 600 of FIG. 6 as the searcher would be unlikely to deduce if any specific person was a user in the social network. This is in contrast to the situation where a searcher enters a specific name as a search term, and there is only one search result.

If the alternative search results page 600 of FIG. 6 is used in such a scenario, and the searching user or searcher (e.g., performing act 106 of FIG. 1) does not have permission to view that one search result, the alternative search results page 600 of FIG. 6 will effectively notify the searcher in the accompanying explanation 626 of FIG. 6 that the website or server found (e.g., in act 108) one person (e.g., member or specific user) that matches the searcher's search term (e.g., entered in act 106). But the searcher does not have permission to view that specific user. The searcher may thereby deduce that the specific person they searched for is part of the social network (e.g., 200 shown in FIG. 2). This may be considered to breach the privacy of the matching person or specific user even though their profile is not displayed (e.g., in act 112, on page 600, or both), in some embodiments.

In some embodiments, the decision to use the standard search results page 500 of FIG. 5 or the alternative search results page 600 of FIG. 6 may be tied to a specific threshold number of search results, for example. In other embodiments, on the other hand, the algorithm may be more complex and may include additional or different parameters.

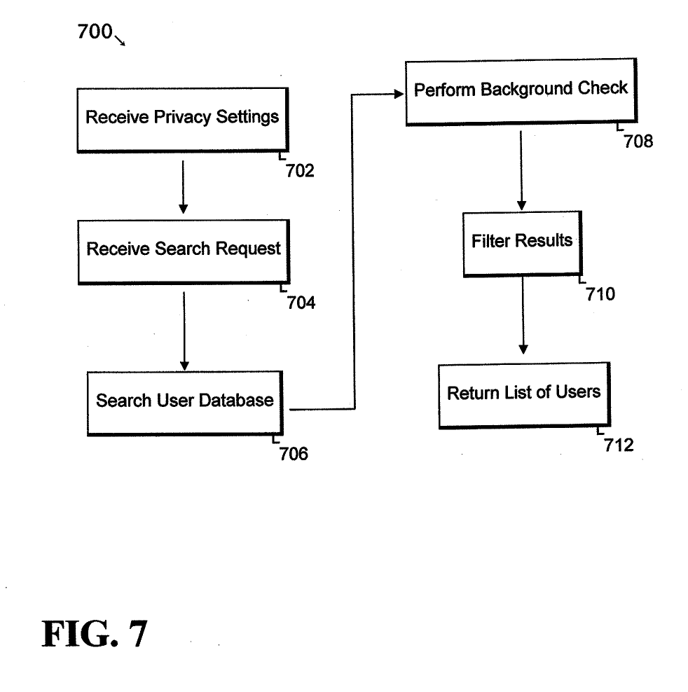

FIG. 7 illustrates, among other things, various methods of obtaining or providing search results in a computer-based social network in a manner that allows members or users to maintain a certain level of control over their privacy. These methods generally include, in various orders, at least certain acts, examples of which are illustrated by method 700. One such act, for example, in some embodiments, is act 702 of receiving privacy settings. In act 702, privacy settings may be received, for example, at a web server, from multiple or specific users of the computer-based social network (e.g., network 200 shown in FIG. 2), for instance.

In some embodiments, privacy settings may be received (e.g., in act 702) for each of the specific users, for example, for allowing searchers to access information concerning each of the specific users. Privacy settings may be received via page 300 shown in FIG. 3 and described above with reference thereto, for example. In particular embodiments, the privacy settings include at least one permission search term (e.g., entered in term box 342 shown in FIG. 3) for each of the specific users, for example.

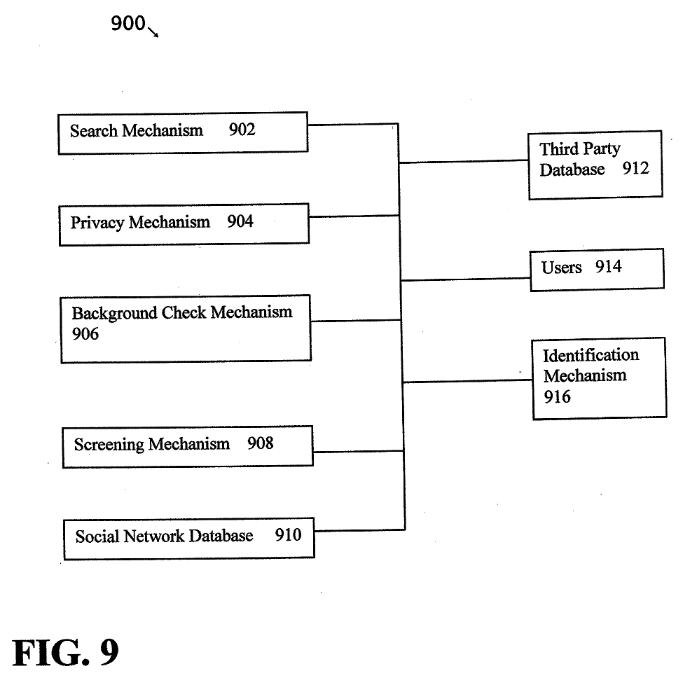

Another act, in some embodiments, is act 704 of receiving (at a web server, for instance) a search request. This search request may have been submitted in act 106 shown in FIG. 1, for example, and may be entered and received via one or more of web pages 400, 500, and 600 shown in FIGS. 4-6 and described above with reference thereto. A search request may be received (e.g., in act 704), for example, from a searcher, who may be a user of the computer-based social network (e.g., network 200 shown in FIG. 2), for example, to view specific users in the (e.g., same) computer-based social network that match at least one particular search term. In some embodiments, this particular search term is provided by the searcher with the request, for example (e.g., entered in term box 342 shown in FIG. 3). At least one act (e.g., act 706), in some embodiments, involves searching some or all of a membership or user database (e.g., social network database 910 shown in FIG. 9 and described below with reference thereto), for example.

In a number of embodiments, for example, act 706 involves searching to find specific users of the computer-based social network that match the at least one particular search term (e.g., received in act 704). In some embodiments, the user database (e.g., searched in act 706) contains information concerning the users of the computer-based social network (e.g., users of network 200 shown in FIG. 2), for example. This information may be sorted according to which user it pertains to, for instance.

Another act, act 710, in a number of embodiments, involves filtering results. In some embodiments, act 710 involves filtering out results that the searcher does not have permission to review, for example. In certain embodiments, act 710 may be similar or identical to act 110 shown in FIG. 1 and described above with reference thereto, for example. In particular, in some embodiments, for example, the results filtered in act 704 are from the searching of the user database (e.g., in act 706 of FIG. 7 or act 108 of FIG. 1). In some embodiments, the permission used for filtering in act 710 is controlled by the specific users of the computer-based social network that were identified in the searching of the user database (e.g., in act 706). Further, in certain embodiments, the permission is based on or controlled by, privacy settings received in act 702, for example. In some embodiments, the permission used for filtering results in act 710 is received via page 300 shown in FIG. 3, for instance.

In particular embodiments, the user (e.g., of social network 200, from whom the search request is received in act 704, via page 300, or both) or searcher, has a biography database (e.g., within social network database 910 shown in FIG. 9 and described below with reference thereto). In some such embodiments, the filtering out (e.g., of act 710) includes evaluating whether the permission search term (e.g., received in act 702 as part of privacy settings, for instance, via term box 342 shown in FIG. 3) is found in the biography database of the searcher, for instance.

Still referring primarily to FIG. 7, certain embodiments include act 712 of returning to the searcher, for example, for display in the searcher's browser, for instance, a list of the specific users of the computer-based social network that match the at least one particular search term (e.g., received in act 704) and that the searcher has permission to review (e.g., according to the privacy settings entered by the specific users in act 702). In a number of embodiments, act 712 may be similar or identical to act 112 shown in FIG. 1, for example. In various embodiments, the list of specific users may be returned (e.g., in act 712), for example, via one or more of pages 400, 500, and 600 shown in FIGS. 4-6 and described above with reference thereto, for instance. But in a number of embodiments, the list returned in act 712, for example, excludes specific users of the computer-based social network (e.g., network 200 shown in FIG. 2) that the user (e.g., who requested the search in act 704) or searcher does not have permission to view (e.g., according to the privacy settings entered by the specific users in act 702).

In particular embodiments, the privacy settings (e.g., received from the specific users in act 702) specifically include an option for the specific users to enter a required number of connections that a searcher must have in order to view the specific users, for instance. Examples include entering the number of connections in one or more of locations 334, 336, and 340 shown in FIG. 3 and described above with reference thereto.

The specific users (e.g., in act 702) may enter or select such a number on a web page, such as page 300 shown in FIG. 3 and described above, for example. In some such embodiments, the act of filtering or filtering out (e.g., act 710) specifically includes filtering out any of the multiple members or specific users, for example, who require in privacy settings (e.g., received from the specific users in act 702) a required number of connections that is more than the actual number of connections existing for the user (e.g., from whom the search request was received in act 704) or searcher. This actual number may be a current number, for example, and may change over time, for instance, in some embodiments.

Moreover, in particular embodiments, the act of returning to the searcher the list of the specific users of the computer-based social network that match the at least one particular search term and that the searcher has permission to review (e.g., act 712) includes communicating to the searcher circumstances under which the searcher would have permission (e.g., received from the specific users in act 702) to view more of the specific users of the computer-based social network that match the at least one particular search term (e.g., received from the searcher in act 704).

Further, in some embodiments, these circumstances include the searcher having more connections with various users of the computer-based social network, for example. FIG. 6 described above illustrates an example of such an act of communicating circumstances under which the searcher would have permission to view more specific users of the computer-based social network. As described above with reference to FIG. 6, this feature or act may encourage users, who may be the searcher, to establish more connections with other users.

In addition, or in the alternative, in some embodiments, the privacy settings (e.g., received in act 702 of method 700) include an option for the specific users to enter (e.g., received in act 702, via page 300, or both) a required number of connections that a user (e.g., from whom a search request is received in act 704) or searcher must have in common with the specific user, for example. As used herein one way to provide “an option” to enter certain data is to provide a web page with a specific prompt for that data, such as the radio buttons shown in FIG. 3, for example. In some such embodiments, the act of filtering (e.g., act 710) includes filtering out any of the specific users who require in privacy settings (e.g., received in act 702) a required number of connections in common that is more than the actual number of connections in common existing with the searcher, for instance.

In a number of embodiments, as another example, the privacy settings (e.g., received in act 702) specifically include an option (e.g., in a web page such as page 300 shown in FIG. 3) for the specific users or specific users to enter a required percentage of connections that a searcher must have in order to see the specific users. In a number of such embodiments, the act of filtering (e.g., act 710) includes filtering out any of the specific users who require in privacy settings a required percentage of connections that is more than the actual percentage of connections existing for the searcher, for example. In some embodiments, this percentage is a percentage of the total number of users in the computer-based social network (e.g., network 200 shown in FIG. 2), for example.

In certain embodiments, the privacy settings (e.g., received in act 702) specifically include an option for the specific users to enter a required number of common profile features that a searcher must have. In various such embodiments, the act of filtering (e.g., act 710) includes filtering out any of the specific users who require in privacy settings (e.g., received in act 702) a required number of common profile features that is more than the actual number of common profile features existing for the searcher. Profile features may be search for, for example, in part or all of social network database 910 shown in FIG. 9 and described below.

Still further, in particular embodiments, the communicating to the user (e.g., from whom the search request was received in act 704), or searcher, circumstances under which the searcher would have permission to view more of the specific users of the computer-based social network that match the at least one particular search term (e.g., in act 712, page 600, or both), is performed if, or only if, the list of the specific users of the computer-based social network that match the at least one particular search term exceeds a threshold. Such a threshold may be 1, 2, 3, 4, 5, 6, 7, 8, 9, 10, 12, 15, or another number of specific users, for example. As described above with reference to FIG. 6, such a feature may prevent information about a specific user from being disclosed by virtue of the fact that information would be available under differing circumstances.

In particular embodiments, the privacy settings (e.g., received in act 702) specifically include an option for the specific users to request that a background check be performed (e.g., in act 708), for example, on the searcher, for instance, via a network such as a wide area network or even the Internet. In particular embodiments, a background check is performed (e.g., in act 708) if (or only if) at least one of the users of the computer-based social network that match the at least one particular search term (e.g., identified in act 706) has requested (e.g., in privacy settings received in act 702) that the background check be performed (e.g., in act 708). Thus, the act 708 may be skipped when not requested, in some embodiments.

On the other hand, in some embodiments, the background check may be performed in advance, at particular times, at regular intervals, or the like, and the results of the background checks (e.g., for all users or all potential searchers) may be stored in a database, for example. In some embodiments, background checks may be repeated to check for updated information, for instance.

In a number of embodiments act 708 of performing background checks, or another act, may include authenticating the identity of the searcher, for example. The identity of the searcher may be authenticated, for example, using one or more third party websites or databases, for example. This may prevent a searcher from obtaining information that they would not otherwise be entitled to by assuming a non-existent identity, for instance. In some embodiments, other aspects of the searcher may be authenticated, for example, aspects relevant to whether they are entitled to receive certain search results. In particular embodiments, authentication may detect or prevent users or searchers from assuming the identity of another person, as another example. In some embodiments, user identities may be verified when they join the social network, when a background check is performed on them (e.g., act 708) or when they request a search as examples

Further, in various embodiments, if the user (e.g., from whom the search was requested in act 704) or searcher tails the background check (e.g., performed in act 708), method 700 includes an act of filtering out (e.g., in act 710) the specific users of the computer-based social network that match the at least one particular search term (e.g., received in act 704) that requested that the background check be performed. In different embodiments, a searcher may fail a background check, for example, if their name is found in a third-party database (e.g., database 912 shown in FIG. 9 and described below), if there name is not found in a database, or if their name is found in conjunction with particular information in a third-party database, as examples.

Certain such methods further include, for example, in act 712, an act of returning to the user (e.g., from whom the search was requested in act 704), or searcher, for display in the searcher's browser, for example, a list of the specific users of the computer-based social network that match the at least one particular search term (e.g., received in act 704) and that have not requested (e.g., in privacy settings received in act 702) that the background check be performed (e.g., in act 708). In a number of embodiments, this list (e.g., returned in act 712) may exclude, however, specific users of the computer-based social network that requested (e.g., in privacy settings received in act 702) that the background check be performed (e.g., in act 708), for instance (e.g., if or when the searcher failed the background check).

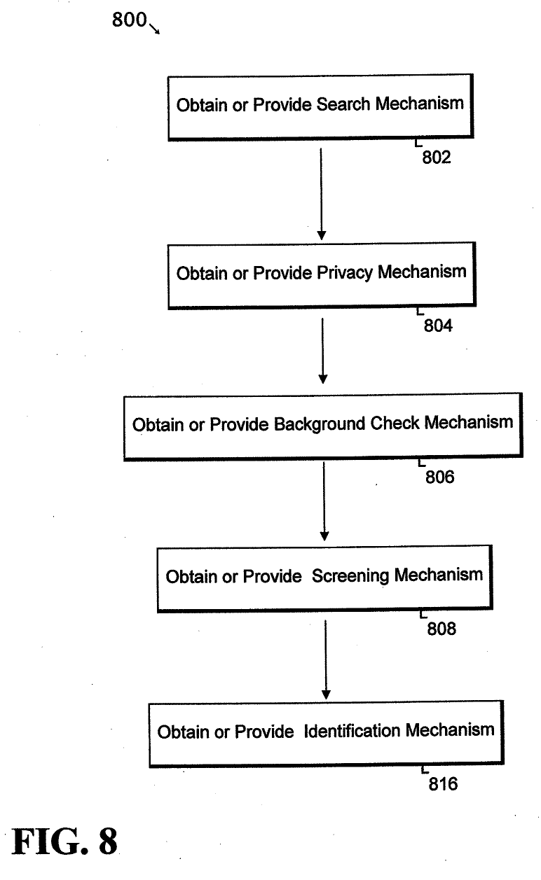

FIGS. 8 and 9 illustrate, among other things, a number of systems and methods of controlling undesired unsolicited communications between users in a computer-based social network and various systems and methods of obtaining or providing search results in a computer-based social network in a manner that allows users to maintain a certain level of control over their privacy. Method 800 shown in FIG. 8 includes, for example, several acts, different combinations of which may be found in various orders in different embodiments of the invention. In the embodiment illustrated, method 800 includes act 802 of obtaining or providing a search mechanism (e.g., a search mechanism) for users of the social network (e.g., network 200 shown in FIG. 2) or searchers to be able to search (e.g., in act 106 shown in FIG. 1) for specific users meeting a search criteria provided by the searchers, for example.

An example of such a search mechanism, and of one component of system 900, is search mechanism 902 shown in FIG. 9. Search mechanism 902, and other mechanisms shown in system 900 may be or include software, code, or instructions, for example, which, in the case of mechanism 902, may be used to perform searching. In some embodiments, software or instructions may be stored in a computer readable file, stored or delivered on a computer-readable storage medium, transmitted electronically, delivered over the Internet, delivered through the mail, loaded on a server, loaded on a computer, or a combination thereof, as examples. In various embodiments, search mechanism 902 may search social network database 910, for example, may provide one or more web pages (e.g., pages 400, 500, and 600 shown in FIGS. 4-6) for receiving a search request, or the like.

In various embodiments, the search criteria may include properties or characteristics of the individuals or specific users being searched for, such as, via their profession, business, education, age, gender, interests, expertise, number of connections, name, or the like. In some embodiments, the search criteria may include one or more keywords or search terms, for example. In particular embodiments, search criteria may include logic or Boolean operators such as one or more “and”, “or”, “except for” or other operators, for example.

Further, certain embodiments include act 804 of obtaining or providing a privacy mechanism (e.g., 904) for specific users (e.g., 914) of the social network to be able to enter privacy settings provided by the specific users, as another example. In some embodiments, the privacy settings define characteristics of the searchers (who use search mechanism 902), for instance. Privacy mechanism 904 may provide web page 300 to receive privacy instructions, for example. Privacy settings may be stored in social network database 910, for example, sorted according to the user to which it pertains. Specific members or users (e.g., 914) may each have their own privacy settings stored in database 910. In different embodiments, database 910 may consist of one or more storage devices or storage locations, for example.

Still further, various embodiments include act 808 of obtaining or providing a screening mechanism (e.g., 908) for screening search results, in some embodiments, when the search mechanism 902 identifies a specific user meeting the search criteria (e.g., provided through search mechanism 902), the screening mechanism 908 then evaluates whether the searcher or user who performed the search (e.g., using search mechanism 902) meets (e.g., satisfies) the privacy settings provided by the specific user via the privacy mechanism 904, for example. In certain embodiments, this specific user is identified to the searcher (e.g., using identification mechanism 916 provided in act 816) only if the searcher meets the privacy settings entered through the privacy mechanism 904 by the specific user. Identification mechanism 916 may perform act 112, act 712, or both, for example, via one or more of pages 400, 500, and 600, for instance.

In a number of embodiments, method 800 includes act 816 of obtaining or providing an identification mechanism (e.g., 916) that, for example, identifies to the searchers the specific users identified by the search mechanism (e.g., 902) that are not screened out by the screening mechanism (e.g., 908). In some such embodiments, the identification mechanism 916 may specifically include instructions to communicate to the searcher circumstances under which the searcher would have permission to view more users of the computer-based social network, for example, that were identified by the search mechanism (e.g., 902), Such communication may be accomplished via page 600 shown in FIG. 6, for example, through provocative question 624, and accompanying explanation 626, for instance.

In particular embodiments, identification mechanism 916 includes instructions to communicate to the searcher circumstances under which the searcher would have permission to view more users of the computer-based social network that were identified by the search mechanism (e.g., 902), only if the list of the specific users identified by the search mechanism exceeds a threshold, for instance, such as described herein. In certain embodiments, identification mechanism 916 may return a list of members or specific users, such as described herein with reference to act 712 of method 700 shown in FIG. 7, for example.

In certain embodiments, screening mechanism 908 may perform act 110 shown in FIG. 1, may perform act 710 shown in FIG. 7, or both, or similar functions. In different embodiments, all of the search results may be collected (e.g., via search mechanism 902, act 706, or both) before filtering or screening is done (e.g., via screening mechanism 908, act 710, act 110, or a combination thereof), or these mechanisms 902 and 908 may act concurrently performing acts 706, 108, 710, 110, or a combination thereof, or similar acts, concurrently. Although discrete mechanisms are shown in FIG. 9, in some embodiments, some or all of the different mechanism may be combined into fewer or just one program or blocks of code, or may be divided differently than as shown and described herein.

In particular embodiments, the privacy settings (e.g., entered through privacy mechanism 904) specifically includes a school attended by the searcher or user who performed the search (e.g., via search mechanism 902), a number of connections within the social network of the searcher or user who performed the search (e.g., via search mechanism 902), or both, as examples. Further, in some embodiments, the act (e.g., act 110 or 710) of evaluating whether the searcher or user who performed the search (e.g., via search mechanism 902) meets the privacy settings provided by the specific user via the privacy mechanism (e.g., 904) includes evaluating (e.g., using screening mechanism 908) whether a school attended by the searcher (e.g., who performed the search via search mechanism 902, which may have been received in act 704 shown in FIG. 7, for example) is the same as a school attended by the specific user (e.g., identified in the search performed by search mechanism 902), for instance.

Moreover, in various embodiments, the number of connections mentioned above (e.g., used for screening or filtering by mechanism 908 or in act 110 or 710) is or includes a total number of the searcher's connections (e.g., of the user who requested the search via search mechanism 902, in act 106, in act 704, or a combination thereof). In particular embodiments, the social network (e.g., 200 shown in FIG. 2) includes multiple specific groups which include a particular specific group, and the number of connections (e.g., used for screening or filtering by mechanism 908 or in act 110 or 710) is or includes a total number of the searcher's total connections that are within the particular specific group, as another example. In fact, in some embodiments, the social network includes multiple specific groups which include a particular specific group, and the number of connections includes a percentage of the searcher's total connections that are within the particular specific group. Examples of such specific groups include groups having certain professions, groups having certain hobbies or interests, groups having certain religious affiliations, groups that attended or once attended specific schools, etc.

In some embodiments, the number of connections (e.g., used for screening or filtering by mechanism 908 or in act 110 or 710) includes a total number of common connections between the searcher (e.g., who requested the search via search mechanism 902) and the specific user (e.g., identified by search mechanism 902). Further, in some embodiments, the number of connections includes a percentage of the searcher's total connections that are common connections between the searcher (e.g., who requested the search via search mechanism 902) and the specific user (e.g., identified by search mechanism 902), as another example.

Further, a number of embodiments include an act 806 of obtaining or providing a mechanism to perform background checks (e.g., fourth or background check mechanism 906) on the searchers (e.g., 914) or users of the social network (e.g., network 200 shown in FIG. 2). In some embodiments, the background check mechanism 906 is configured to access at least one external database, such as third party database 912 shown in FIG. 9, over a wide area network (e.g., the Internet), for example, in order to perform the background checks (e.g., act 708 shown in FIG. 7).

In some such embodiments, the screening mechanism 908 evaluates whether the searcher or user who performed the search (e.g., via search mechanism 902 or in act 106) meets or satisfies the privacy settings provided by the specific user (e.g., identified by search mechanism 902 or in act 108 or 706) via privacy mechanism 904 for instance. In particular embodiments, the screening mechanism 908 uses at least one of the background checks (e.g., performed by background check mechanism 908) to evaluate whether the searcher or person who performed the search (e.g., via search mechanism 902) meets the privacy settings provided by the specific user via the privacy mechanism 904.

Further, in a number of embodiments, communication from the searcher (e.g., who requested the search via search mechanism 902) to the specific user (e.g., who was identified via search mechanism 902) is facilitated by a communication mechanism (e.g., which may be part of identification mechanism 916, for example) only if the searcher (e.g., who requested the search via search mechanism 902) meets the privacy settings entered through the privacy mechanism 904 by the specific user (e.g., identified by search mechanism 902). A communication mechanism, for example, may, in some embodiments, facilitate sending of an e-mail, instant message, or the like, for instance.

In some embodiments, when the search mechanism 902 identifies a specific user meeting the search criteria (e.g., entered via search mechanism 902), the screening mechanism 908 then evaluates whether the searcher (e.g., who requested the search via search mechanism 902) meets the privacy criteria or privacy settings provided by the specific user via privacy mechanism 904, for example. In certain embodiments, the specific user (e.g., identified by search mechanism 902) is identified (e.g., by identification mechanism 916) to the searcher (e.g., who requested the search via search mechanism 902) only if the searcher meets the privacy settings entered through privacy mechanism 904 by the specific user (e.g., identified by search mechanism 902), for instance.

In a number of embodiments, the wide area network is the Internet, for example. Further, in some embodiments, the external database (e.g., third party database 912) is a governmental database, meaning that the external database is maintained by a federal, state, or local level of government, as examples. Specifically, in some embodiments, multiple of the background checks (e.g., performed by mechanism 906) include evaluating (e.g., using mechanism 908) whether the searcher (e.g., who requested the search via search mechanism 902) has a particular record such as a criminal record, is a registered offender of a particular type (e.g., that requires subsequent registration), has been convicted of a particular category of offense that may make him a threat to a particular group of potential victims (e.g., children), or a combination thereof, as examples.

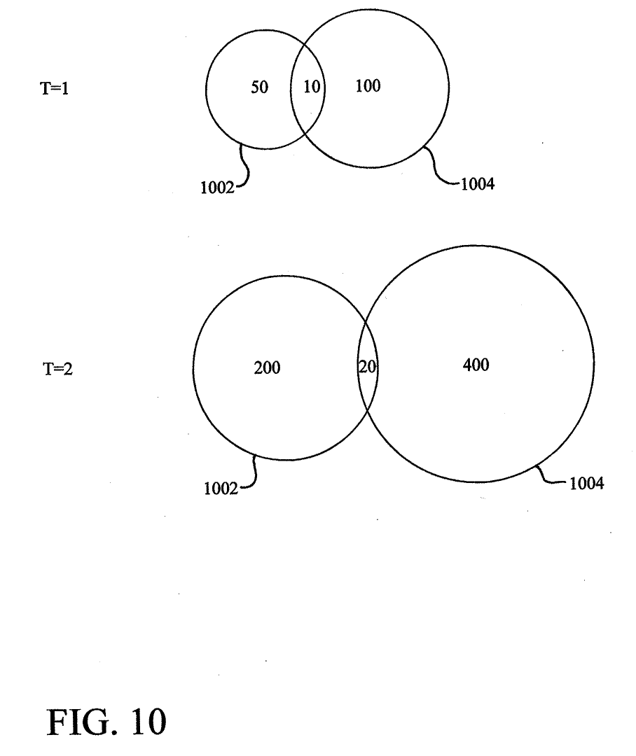

FIG. 10 illustrates, among other things, the dynamic nature of certain embodiments of the invention. In this example, at a first time T=1, user 1002 has 50 connections within a computer-based social network (e.g., network 200 shown in FIG. 2), user 1004 has 100 connections within that same social network, and user 1002 and 1004 have 10 connections in common. Over time, however, in this example, both user 1002 and user 1004 establish more connections within the computer-based social network (e.g., network 200 shown in FIG. 2). In this example, at a second time T=2, user 1002 has 200 connections within the computer-based social network, user 1004 has 400 connections within that same social network, and user 1002 and 1004 have 20 connections in common.

Thus, in this example illustrated in FIG. 10, while the total number of connections of each user (e.g., 1002 and 1004) has increased, and the total number of connections that the two users have in common has increased, the percentage of common connections that the two users (e.g., 1002 and 1004) have in common has decreased. Specifically, the percentage of connections that the two users have in common has gone from 10 percent of the connections of user 1004 at time T=1 to 5 percent of the connections of user 1004 at time T=2. In addition, the percentage of connections that the two users have in common has gone from 20 percent of the connections of user 1002 at time T=1 to 10 percent of the connections of user 1002 at time T=2. In other words, although both users' (e.g., 1002 and 1004) social communities are growing (e.g., their number of contacts is increasing) in the time from T=1 to T=2, their social communities are diverging (e.g., in terms of percentage of contacts in common).

As a result, if user 1004 has entered a privacy criteria or privacy settings (e.g., received in act 702 through privacy mechanism 904, for instance, obtained or provided in act 804, via page 300, or a combination thereof) that requires that user 1004 only be visible by searchers (e.g., performing acts 102 to 106, searching via page 400, 500, or 600, who's search is received in act 704 and performed in act 706, for instance, via search mechanism 902 which may have been received in act 802, or a combination thereof) that have at least 10 percent common connections (10 percent of user 1004's total connections), then user 1002 would be able to see (e.g., received in act 112 or 712 through identification mechanism 916, for instance, obtained or provided in act 816, via page 400, 500, or 600, or a combination thereof) user 1004 at time T=1, but not at time T=2.

Or in another example, if user 1004 has entered privacy settings that require that user 1004 only be visible by searchers that have at least 15 percent common connections (15 percent of user 1002's total connections), then user 1002 would be able to see user 1004 at time T=1, but not at time T=2. In such a case, the divergence of the social communities of user 1002 and user 1004, in combination with privacy settings that user 1004 has entered, has resulted in user 1004 loosing visibility to user 1002.

On the other hand, if user 1004 has entered privacy settings that require that user 1004 only be visible by searchers that have at least 100 connections total, then user 1002 would be able to see user 1004 at time T=2, but not at time T=1. Furthermore, if user 1004 has entered privacy settings that require that user 1004 only be visible by searchers that have at least 15 total common connections, then user 1002 would be able to see user 1004 at time T=2, but not at time T=1. In these cases, user 1004 has chosen to be revealed to searchers having larger social communities rather than having social communities that are more convergent.

Consequently, in a number of embodiments, depending on the privacy settings entered (e.g., in page 300) by specific users of the computer-based social network (e.g., network 200 shown in FIG. 2), different ones of the specific users may be visible (e.g., via page 400, 500, or 600) to the searcher at different times, depending on the connections with specific users then existing for the searcher, the connections with specific users then existing for the specific users, or both.

Various embodiments of the invention include various combinations of the acts, structure, components, and features described herein or shown in the drawings. Moreover, certain procedures may include acts such as obtaining or providing various structural components described herein, or obtaining or providing components that perform functions described herein, as well as advertising and selling products that perform functions described herein or contain structure or instructions to perform functions described herein, for instance, through distributors, dealers, or over the Internet. The invention also contemplates various means for accomplishing the various functions described herein or apparent from the structure and acts described.

1. A system for providing search results in a computer-based social network in a manner that allows users to maintain a certain level of control over their privacy, the system comprising:
a search mechanism for searchers to be able to search for specific users meeting a search criteria provided by searchers, wherein the searchers include users of the social network;
a privacy mechanism for the specific users of the social network to be able to enter one or more privacy settings provided by the specific users, wherein the privacy settings define characteristics of the searchers;
a screening mechanism for screening search results, wherein, when the search mechanism identifies a specific user meeting the search criteria, the screening mechanism then evaluates whether the searcher meets the privacy settings provided by the specific user via the privacy mechanism, and wherein the specific user is identified to the searcher only if the searcher meets the privacy settings entered through the privacy mechanism by the specific user; and
an identification mechanism that identifies to the searchers the specific users identified by the search mechanism that are not screened out by the screening mechanism, wherein the identification mechanism comprises instructions to communicate to the searcher circumstances under which the searcher would have permission to view more of the specific users of the computer-based social network that were identified by the search mechanism, only if the list of the specific users identified by the search mechanism exceeds a threshold;
wherein the privacy settings include a number of connections of the searcher within the social network, and wherein the number of connections comprises at least one of:
a total number of common connections between the searcher and the specific user, or
a percentage of the searcher's total connections that are common connections between the searchers and the specific user.

2-11. (canceled)
